(19) United States
(12) Patent Application Publication
(10) Pub. No.: US 2026/0010410 A1
(43) Pub. Date: Jan. 8, 2026

(54) BLOCKCHAIN TRANSACTION ALLOCATION METHOD AND APPARATUS

(71) Applicant: CHINA UNIONPAY CO., LTD., Shanghai (CN)

(72) Inventors: Yan HUANG, Shanghai (CN); Zhichen TONG, Shanghai (CN); Yong MIN, Shanghai (CN); Yu ZHOU, Shanghai (CN)

(73) Assignee: CHINA UNIONPAY CO., LTD., Shanghai (CN)

(21) Appl. No.: 19/112,173

(22) PCT Filed: Oct. 20, 2023
(86) PCT No.: PCT/CN2023/125668

§ 371 Date: Mar. 14, 2025

(30) Foreign Application Priority Data
Nov. 18, 2022 (CN) 202211450950.5

(51) Int. Cl. G06Q 20/38; G06Q 20/40

(52) U.S. Cl. CPC G06F 9/5066; G06F 9/466; G06F 9/5072; G06F 2209/5011

(57) ABSTRACT

A blockchain transaction allocation method performed by any node in a blockchain system includes: determining a bootstrap block pointed to by a target block of a transaction to be allocated, where the bootstrap block is a legal block with a maximum logical clock detected by a local node when generating the target block; determining a consensus member group for allocating a target transaction based on the bootstrap block, and generating a target tag hash based on a transaction hash of the target transaction and a block hash of the bootstrap block; assigning a node number to a target node assigned to the target transaction based on the target tag hash and the total quantity of nodes in the consensus member group; and if the node number of the target node is the node number of the local node, adding the target transaction to the target block.

### CROSS-REFERENCE TO RELATED APPLICATIONS

This application is a national phase entry under 35 U.S.C. § 371 of International Application No. PCT/CN2023/125668, filed on Oct. 20, 2023, which claims priority to Chinese Patent Application No. 202211450950.5, filed with the China National Intellectual Property Administration on Nov. 18, 2022 and entitled “Blockchain Transaction Allocation Method and Apparatus”, the entire contents of which are incorporated herein by reference.

### TECHNICAL FIELD

Embodiments of the present invention relate to the field of blockchain technology, and in particular to a blockchain transaction allocation method and apparatus.

### BACKGROUND

Blockchain is a new application model of computer technologies such as distributed data storage, peer-to-peer transmission, consensus mechanism, and encryption algorithm. The blockchain consensus protocol is the key technology of the underlying blockchain platform, which directly determines the security and performance of the blockchain system.

The consensus protocol based on parallel multi-chain architecture can significantly improve the block throughput in the blockchain network. The block throughput refers to the quantity of valid on-chain blocks per unit time. Since concurrent blocks contain multiple duplicate transactions, when the block throughput increases, the processing capacity of valid transactions in the blockchain network (i.e., transaction throughput) is not effectively improved.

### SUMMARY

Embodiments of the present application provide a blockchain transaction allocation method and apparatus for allocating transactions in a blockchain network.

In a first aspect, embodiments of the present application provide a blockchain transaction allocation method, which is performed by any node in a blockchain system and includes:
determining a bootstrap block pointed to by a target block of a target transaction to be allocated, where the bootstrap block is a legal block with a maximum logical clock detected by a local node when generating the target block;
determining a consensus member group for allocating the target transaction based on the bootstrap block, and generating a target tag hash based on a transaction hash of the target transaction and a block hash of the bootstrap block;
assigning a node number to a target node assigned to the target transaction based on the target tag hash and a total quantity of nodes in the consensus member group;
adding the target transaction to the target block based on that the node number of the target node is a node number of the local node.

By allocating transactions to target nodes for processing, the problem of duplicate transactions in high-concurrency blockchain systems can be effectively solved, and the actual transaction processing capabilities of the blockchain network can be significantly improved, thereby improving the throughput capacity of actual transactions in the blockchain network. In addition, by randomly allocating transactions to nodes of blockchains, dynamic adjustments can be made based on the latest status of blocks, effectively preventing transactions from being filtered or monopolized by specific nodes, thereby improving the security and fairness of the entire blockchain network.

Optionally, after determining the bootstrap block pointed to by the target block of the target transaction to be allocated, the method further includes:
adding the block hash of the bootstrap block to a corresponding field of the target block.

Optionally, the determining a consensus member group for allocating the target transaction based on the bootstrap block includes:
monitoring latest blocks of main chains in sub-blockchains;
determining the consensus member group for allocating the target transaction based on the bootstrap block, based on that a difference between logical clocks of any two latest blocks is less than or equal to a preset difference, or based on that a difference between block heights of any two latest blocks is less than or equal to the preset difference.

Optionally, based on that the difference between the logical clocks of two latest blocks is greater than the preset difference, or based on that the difference between the block heights of two latest blocks is greater than the preset difference, the transaction is randomly allocated to the target block, or the transaction is not added to the target block.

Optionally, the determining the consensus member group for allocating the target transaction based on the bootstrap block includes:
determining, from main chains of sub-blockchains, a plurality of historical blocks that meet a preset condition, wherein the preset condition refers to: a distance from a logical clock or height of the historical block to a logical clock or height of the bootstrap block is greater than or equal to a preset difference;
determining the consensus member group based on the plurality of historical blocks.

Optionally, after determining the consensus member group based on the plurality of historical blocks, the method further includes:
sorting a plurality of nodes in the consensus member group according to address information of the plurality of nodes; and assigning a node number to each of the plurality of nodes based on a result of the sorting.

Optionally, the assigning the node number to the target node assigned to the target transaction based on the target tag hash and the total quantity of nodes in the consensus member group includes:
taking a remainder of the total quantity of nodes in the consensus member group divided by the target tag hash to obtain a remainder result;
taking the remainder result as the node number of the target node.

Optionally, based on that the node number of the target node is not the node number of the local node, the target transaction is skipped.

Optionally, a block to be verified broadcasted by another node is received.

A transaction allocation relationship between a historical transaction contained in the block to be verified and the another node that generates the block to be verified is verified.

If the verification passes, it is determined that the block to be verified is a legal block.

Optionally, the verifying the transaction allocation relationship between the historical transaction contained in the block to be verified and the another node that generates the block to be verified includes:
determining a tag hash to be verified based on a transaction hash of the historical transaction and a block hash of a bootstrap block corresponding to the block to be verified; and determining a historical consensus member group for allocating the historical transaction based on the bootstrap block corresponding to the block to be verified;
determining a node number of a historical node corresponding to the historical transaction based on the tag hash to be verified and a total quantity of nodes in the historical consensus member group;
determining that the result of the verifying is pass based on that the node number of the historical node is a node number of the another node that generates the block to be verified.

In a second aspect, embodiments of the present application provide blockchain transaction allocation apparatus. Any node in a blockchain system includes:
a bootstrap module, configured to determine a bootstrap block pointed to by a target block of a target transaction to be allocated, wherein the bootstrap block is a legal block with a maximum logical clock detected by a local node when generating the target block;
a processing module, configured to determine a consensus member group for allocating the target transaction based on the bootstrap block, and to generate a target tag hash based on a transaction hash of the target transaction and a block hash of the bootstrap block;
a numbering module, configured to assign a node number to a target node assigned to the target transaction based on the target tag hash and a total quantity of nodes in the consensus member group;
a matching module, configured to add the target transaction to the target block based on that the node number of the target node is a node number of the local node.

By allocating transactions to target nodes for processing, the problem of duplicate transactions in high-concurrency blockchain systems can be effectively solved, and the actual transaction processing capabilities of the blockchain network can be significantly improved, thereby improving the throughput capacity of actual transactions in the blockchain network. In addition, by randomly allocating transactions to nodes of blockchains, dynamic adjustments can be made based on the latest status of the block, effectively preventing transactions from being filtered or monopolized by specific nodes, thereby improving the security and fairness of the entire blockchain network.

Optionally, the bootstrap module is configured to:
add the block hash of the bootstrap block to a corresponding field of the target block.

Optionally, the processing module is configured to:
monitor latest blocks of main chains in sub-blockchains;
determine the consensus member group for allocating the target transaction based on the bootstrap block, based on that a difference between logical clocks of any two latest blocks is less than or equal to a preset difference, or based on that a difference between block heights of any two latest blocks is less than or equal to the preset difference.

Optionally, the processing module is configured to:
randomly allocate the transaction to the target block, or not add the target transaction to the target block, based on that the difference between the logical clocks of two latest blocks is greater than the preset difference, or based on that the difference between the block heights of two latest blocks is greater than the preset difference.

Optionally, the processing module is configured to:
determine, from main chains of sub-blockchains, a plurality of historical blocks that meet a preset condition, where the preset condition refers to: a distance from a logical clock or height of the historical block to a logical clock or height of the bootstrap block is greater than or equal to a preset difference;
determine the consensus member group based on the plurality of historical blocks.

Optionally, the processing module is configured to:
sort a plurality of nodes in the consensus member group according to address information of the plurality of nodes; and assign a node number to each of the plurality of nodes based on a result of the sorting.

Optionally, the numbering module is configured to:
take a remainder of the total quantity of nodes in the consensus member group divided by the target tag hash to obtain a remainder result;
take the remainder result as the node number of the target node.

Optionally, the numbering module is configured to:
skip the target transaction based on that the node number of the target node is not the node number of the local node.

Optionally, the processing module is configured to:
receive a block to be verified broadcasted by another node;
verify a transaction allocation relationship between a historical transaction comprised in the block to be verified and the another node that generates the block to be verified;
determine that the block to be verified is a legal block based on that a result of the verifying is pass.

Optionally, the processing module is configured to:
determine a tag hash to be verified based on a transaction hash of the historical transaction and a block hash of a bootstrap block corresponding to the block to be verified; and determine a historical consensus member group for allocating the historical transaction based on the bootstrap block corresponding to the block to be verified;
determine a node number of a historical node corresponding to the historical transaction based on the tag hash to be verified and a total quantity of nodes in the historical consensus member group;
determine that the result of the verifying is pass based on that the node number of the historical node is a node number of the another node that generates the block to be verified.

In a third aspect, embodiments of the present application provide a computer device, comprising a memory, a processor, and a computer program stored in the memory and executable on the processor. The processor executes any of the blockchain transaction allocation methods described in the first aspect above.

In a fourth aspect, embodiments of the present application provide a computer-

readable storage medium storing a computer program executable by a computer device. When the program runs on the computer device, the computer device executes any of the blockchain transaction allocation method described in the first aspect above.

### BRIEF DESCRIPTION OF DRAWINGS

In order to more clearly illustrate the technical solutions in the embodiments of the present invention, the drawings required for use in the description of the embodiments will be briefly introduced below. Obviously, the drawings described below illustrate only some embodiments of the present invention. For ordinary technicians in this field, other drawings can be obtained based on these drawings without paying creative labor.

FIG. 1 is a schematic diagram of a system architecture applicable to an embodiment of the present application.

FIG. 2 is a schematic diagram of a flow chart of a blockchain transaction allocation method provided in an embodiment of the present application.

FIG. 3 is a schematic diagram of a parallel multi-chain architecture provided in an embodiment of the present application.

FIG. 4 is a schematic diagram of a parallel multi-chain architecture provided in an embodiment of the present application.

FIG. 5 is a schematic diagram of a parallel multi-chain architecture provided in an embodiment of the present application.

FIG. 6 is a schematic structure diagram of a blockchain transaction allocation apparatus provided in an embodiment of the present application.

FIG. 7 is a schematic structure diagram of a computer device provided in an embodiment of the present application.

### DETAILED DESCRIPTION

In order to make the purpose, technical solutions and beneficial effects of the present invention more clear and understandable, the present invention is further described in detail below in conjunction with the accompanying drawings and embodiments. It should be understood that the specific embodiments described herein are only used to explain the present invention, and are not used to limit the present invention.

For ease of understanding, the terms involved in the embodiments of the present invention are explained below.

Blockchain: A new application model of computer technologies such as distributed data storage, peer-to-peer transmission, consensus mechanism, and encryption algorithm. Blockchain is essentially a decentralized database, which is a string of data blocks associated and generated using cryptographic methods. Each data block contains information about a batch of network transactions, and is configured to verify the validity of the information (anti-counterfeiting) and to generate the next block. Blockchain can include the blockchain underlying platform, platform product service layer and application service layer.

DAG: Directed acyclic graph. A directed acyclic graph is a directed graph without a cycle. If there is a non-directed acyclic graph which forms a circle by starting from point A to point B and returning to point A via point C, and if the direction of the edge from point C to point A is changed to from point A to point C, then it will turn into a directed acyclic graph. The quantity of spanning trees of a directed acyclic graph is equal to the in-degree product of the nodes with non-zero in-degree.

Genesis Block: The very first block constructed is called the Genesis Block which has a unique ID number. Except for the genesis block, each subsequently constructed block has two ID numbers, one is the ID number of the block itself, and the other is the ID number of the previous block. Through the forward and backward pointing relationship between ID numbers, all blocks are connected in sequence to form a blockchain.

The logical clock of a block is the quantity of blocks from the block to the genesis block along the logical clock line. The blocks passed include the genesis block but not the current block.

The logical clock line of blocks is the linear direction along the bootstrap block path in the blocks to the genesis block.

The block height of a block is the quantity of blocks (including the current block and the genesis block) from the block to the genesis block along the sub-blockchain to which the block belongs.

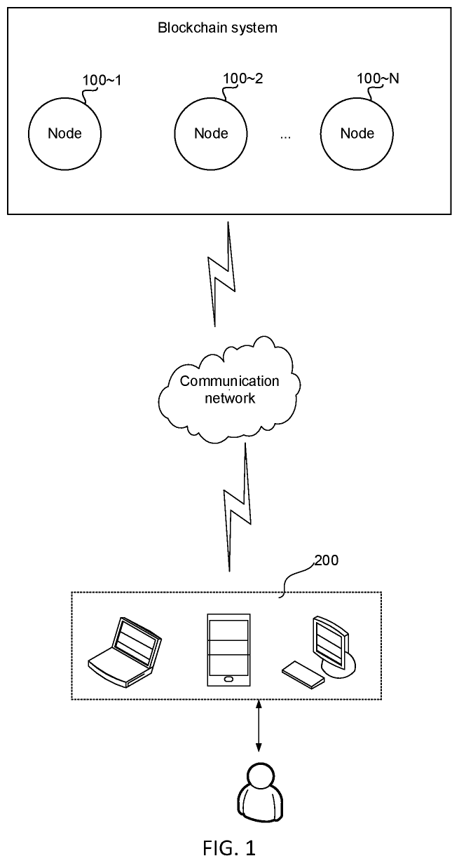

FIG. 1 is a schematic architecture diagram of a blockchain system provided in an embodiment of the present invention. As shown in FIG. 1, the blockchain system may include N nodes, namely node 100-1, node 100-2, . . . , node 100-N, where N is a positive integer. Any two nodes in the blockchain system may have a communication connection, thereby jointly maintaining the blockchain system. Any two nodes may be connected by wire or by wireless, which is not limited here.

In embodiments of the present invention, nodes in the blockchain system can have multiple functions, e.g., routing function, transaction function, consensus function, etc. For example, nodes in the blockchain system can transmit information such as transaction data sent by other nodes to more nodes to achieve communication between nodes; or, nodes in the blockchain system can be used to record all historical transactions; or, nodes in the blockchain system can generate new blocks in the blockchain by verifying and recording transactions.

It should be noted that a node in the blockchain system can be a physical machine (server) or a process or a series of processes running in the server, which is not limited in this application.

As shown in FIG. 1, the system architecture may also include a client device 200. The client device 200 may be connected to any node in the blockchain system by accessing the blockchain network. In an embodiment, the client device 200 can send transaction data to any node in the blockchain system. After receiving the transaction data, a node in the blockchain system can synchronize the transaction data to other nodes in the blockchain system. After receiving transaction data, a node may also store the transaction data in the transaction pool inside the node. Correspondingly, after receiving transaction data synchronized by the node, other nodes may also store the transaction data in the transaction pools inside the other nodes. In this way, if a node determines to process multiple transaction data, it can obtain multiple transaction data from the internal transaction pool and then carry out subsequent transaction processing and block consensus.

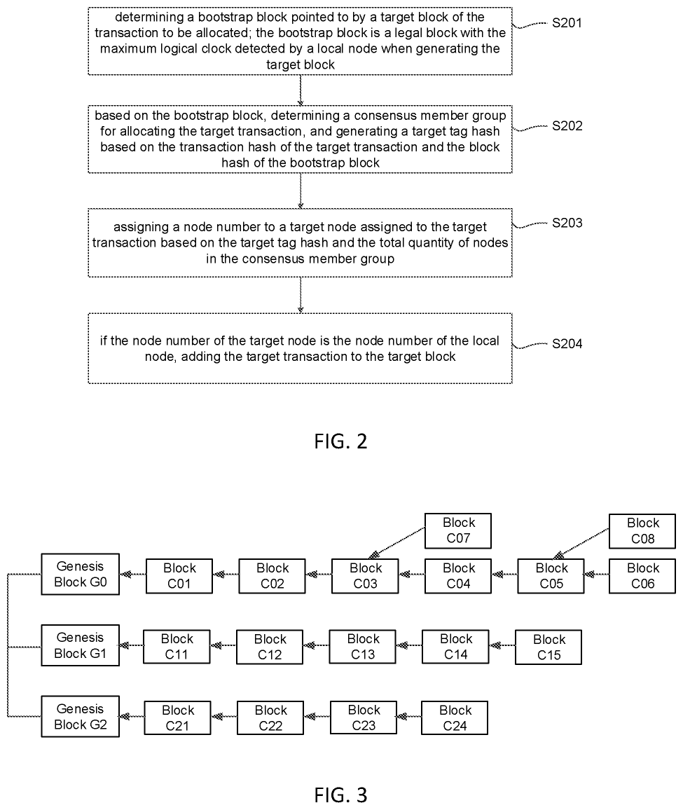

Based on the system architecture diagram as shown in FIG. 1, embodiments of the present application provide a process of a blockchain transaction allocation method, as shown in FIG. 2. The process of the method can be executed by any node in the blockchain system shown in FIG. 1, and includes the following steps.

Step S201, determining a bootstrap block pointed to by a target block of the transaction to be allocated. The bootstrap block is a legal block with the maximum logical clock detected by a local node when generating the target block.

For example, a bootstrap block is determined for the target block of the transaction to be allocated, and the bootstrap block serves as the pointing block of the target block. The bootstrap block is a legal block with the maximum logical clock detected by the local node when generating the target block. The logical clock of a block is the quantity of blocks from the block to the genesis block along the logical clock path corresponding to the block. The logical clock path is the path starting from the target block and extending to the genesis block along a direction pointing to the longest clock block. After connecting the target block with the bootstrap block, the target block and the original block structure form a directed acyclic graph.

Optionally, if the local node has not generated any block, the genesis block is used as the bootstrap block pointed to by the target block of the transaction to be allocated.

In some embodiments, after determining the bootstrap block pointed to by the target block of the transaction to be allocated, the method further includes: adding the block hash of the bootstrap block to the corresponding field of the target block.

Each block in the blockchain contains the block hash of the current block and the block hash of the previous block. The block hash can be used to find the block corresponding to the block hash. After determining the bootstrap block pointed to by the target block of the transaction to be allocated, the block hash of the bootstrap block is added to the corresponding field of the target block to ensure the connection between the target block and the bootstrap block.

Step S202, based on the bootstrap block, determining a consensus member group for allocating the target transaction, and generating a target tag hash based on the transaction hash of the target transaction and the block hash of the bootstrap block.

For example, after determining the bootstrap block pointed to by the target block of the transaction to be allocated, an allocable node that can process the target transaction is further determined. There is at least one allocable node in the whole, including the local node. Multiple allocable nodes and the local node together constitute the consensus member group. The transaction hash of the target transaction and the block hash in the bootstrap block are combined, hash transformation is performed, and a target tag hash is generated.

Step S203, assigning a node number to a target node assigned to the target transaction based on the target tag hash and the total quantity of nodes in the consensus member group.

For example, the quantity of nodes included in the consensus member group is counted, and then based on the target tag hash, the target node assigned to the target transaction is numbered. The target node is a node in the consensus member group.

Step S204: if the node number of the target node is the node number of the local node, adding the target transaction to the target block.

For example, if the node number assigned to the target node is the node number of the local node, the target transaction is added to the target block, and the target transaction allocation is completed.

In some embodiments, if the node number of the target node is not the node number of the local node, the target transaction is skipped.

For example, if the node number assigned to the target node is not the node number of the local node, the target transaction is skipped and judgment for the next transaction is performed.

By allocating transactions to target nodes for processing, the problem of duplicate transactions in high-concurrency block systems can be effectively solved, and the actual transaction processing capabilities of the blockchain network can be significantly improved, thereby improving the throughput capacity of actual transactions in the blockchain network. In addition, by randomly allocating transactions to nodes of blockchains, dynamic adjustments can be made based on the latest status of blocks, effectively preventing transactions from being filtered or monopolized by specific nodes, thereby improving the security and fairness of the entire blockchain network.

In some embodiments, determining the consensus member group for allocating the target transaction based on the bootstrap block also includes: monitoring the latest block of the main chain in each sub-blockchain; if the difference between the logical clocks of any two latest blocks is less than or equal to a preset difference; or, if the difference between the block heights of any two latest blocks is less than or equal to a preset difference, then determining the consensus member group for allocating the target transaction based on the bootstrap block.

For example, the preset difference is a set block interval, denoted as H. The block interval is a preset security parameter and is at least 1. The latest block of the main chain in each sub-blockchain is monitored. The logical clock of the latest block of the main chain in each sub-blockchain is determined. The difference between the logical clocks of the latest blocks of the main chains in every two sub-blockchains is calculated. The difference between the logical clocks of the latest blocks in any two sub-blockchains is determined to be less than the preset quantity of blocks. Alternatively, the difference between the block heights of the latest blocks in any two sub-blockchains is determined to be less than the preset quantity of blocks. The block height of a block is the quantity of blocks passed from the block to the genesis block along the sub-blockchain to which the block belongs (including the current block and the genesis block).

For example, referring to FIG. 3, a parallel multi-chain architecture is provided for an embodiment of the present application. The parallel multi-chain architecture includes sub-blockchain C0, sub-blockchain C1 and sub-blockchain C2. Sub-blockchain C0 includes the genesis block G0, block C01, block C02, block C03, block C04, block C05, block C06, block C07, and block C08. Sub-blockchain C1 includes genesis block G1, block C11, block C12, block C13, block C14, and block C15. Sub-blockchain C2 includes genesis block G2, block C21, block C22, block 23, and block C24. In sub-blockchain C0, the latest block is block C08, the logical clock of block C08 is 6, and the height of block C08 is 7. In sub-blockchain C1, the latest block is block C15, the logical clock of block C15 is 5, and the height of block C15 is 6. In sub-blockchain C2, the latest block is block C24, the logical clock of block C24 is 4, and the height of block C24 is 5.

The preset difference is set to 3. In FIG. 3, it can be seen that the difference between logical clocks of block C08 and block C15 is 1, and the difference between heights of block C08 and block C15 is also 1. The difference between logical clocks of block C08 and block C24 is 2, and the difference between heights of block C08 and block C24 is also 2. The difference between logical clocks of block C15 and block C24 is 1, and the difference between heights of block C15 and block C24 is also 1. In summary, the difference between logical clocks of the latest blocks in any two sub-blockchains and the difference between heights of the latest blocks in any two sub-blockchains are both less than the preset difference.

In some embodiments, if the difference between logical clocks of two latest blocks is greater than a preset difference; or, if the difference between block heights of two latest blocks is greater than a preset difference, the transaction is randomly allocated to the target block, or the transaction is not added to the target block.

For example, if the difference between logical clocks of latest blocks of the main chains in any two sub-blockchains is greater than the preset quantity of blocks, or the difference between block heights of latest blocks of main chains in any two sub-blockchains are greater than the preset quantity of blocks, the target transaction will not be allocated according to the transaction allocation method of the present application. The target transaction allocation ends when the transaction is randomly allocated to the target block, or an empty block is generated directly without adding the transaction to the target block.

In some embodiments, determining a consensus member group for allocating the target transaction based on the bootstrap block includes: determining a plurality of historical blocks that meet a preset condition from the main chain of each sub-blockchain; and determining the consensus member group based on the plurality of historical blocks. The preset condition refers to: the distance to the logical clock or height of the bootstrap block is greater than or equal to a preset difference.

For example, in the main chain of each sub-blockchain, according to the preset difference, that is, the set block interval H, if the difference between the logical clock or height of the historical block and the logical clock or height of the bootstrap block is greater than or equal to the preset difference, then the historical block including the genesis block meets the preset condition. Based on the plurality of historical blocks that meet the preset condition, a consensus member group is determined.

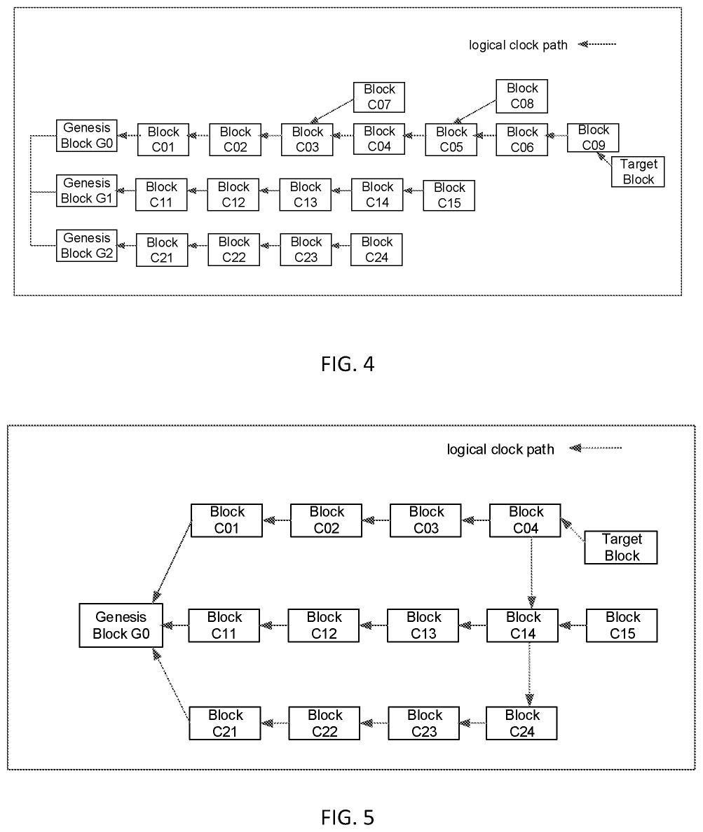

For example, referring to FIG. 4, taking the sub-blockchain where the target block is located as an example, the logical clock path corresponding to the main chain of the target block is set as: target block→block C09→block C06→block C05→block C04→block C03→block C02→block C01→genesis block G0. The preset difference is set to 3. The historical blocks with a distance greater than the preset difference to the bootstrap block (block C09) of the target block are blocks C03, C02, C01, and genesis block GO. The consensus member group is determined based on these historical blocks.

In some embodiments, after determining the consensus member group based on the plurality of historical blocks, it also includes: sorting multiple nodes according to address information of the multiple nodes in the consensus member group, and assigning a node number to each node based on the sorting result.

For example, according to the address information of each node in the consensus

member group, the address information is converted into a binary value. The nodes are sorted according to the binary values of the address information of the nodes. Each node is marked from 0, 1, 2, 3, 4. . . . N-1, N, that is, a node number is assigned to each node. N is the total quantity of nodes in the consensus member group.

In some embodiments, assigning a node number to a target node assigned to the target transaction based on the target tag hash and the total quantity of nodes in the consensus member group, including: taking the remainder of the total quantity of nodes in the consensus member group divided by the target tag hash to obtain a remainder result; and taking the remainder result as the node number of the target node.

For example, the total quantity of nodes in the consensus member group is N. The total quantity of nodes N is divided by the target tag hash to obtain a remainder result, which is used as the node number of the target node.

In some embodiments, a block to be verified broadcasted by another node is received. A transaction allocation relationship between a historical transaction contained in the block to be verified and the node that generates the block to be verified is verified. If the verification passes, the block to be verified is determined to be a legal block.

For example, a node that generates a new block needs to broadcast the new block to other nodes to achieve verification with other nodes. The new block is defined as a block to be verified. The block to be verified broadcasted by another node is received. The block to be verified contains a historical transaction. There is a transaction allocation relationship between the historical transaction and the node that generates the block to be verified. The transaction allocation relationship needs to be verified. If the verification passes, the block to be verified is determined to be a legal block. If the verification fails, the block to be verified is determined to be an illegal block and the block to be verified is refused to be added to the node.

By verifying the transaction allocation relationship between blocks and nodes, the security and legitimacy of blocks in each sub-blockchain can be ensured, and the transaction security of the entire blockchain system can be guaranteed.

In some embodiments, verifying the transaction allocation relationship between the historical transaction contained in the block to be verified and the node that generates the block to be verified, including: determining the tag hash to be verified based on the transaction hash of the historical transaction and the block hash of the bootstrap block corresponding to the block to be verified; and determining a historical consensus member group for allocating the historical transaction based on the bootstrap block corresponding to the block to be verified; determining the node number of a historical node corresponding to the historical transaction based on the tag hash to be verified and the total quantity of nodes in the historical consensus member group; if the node number of the historical node is the node number of the node, it is determined that the verification is passed.

For example, the transaction hash of the historical transaction and the block hash of the bootstrap block corresponding to the block to be verified are combined and hashed to obtain the tag hash to be verified. Based on the logical clock or height of the bootstrap block corresponding to the block to be verified, the historical consensus member group for allocating the historical transaction is determined. The historical nodes in the historical consensus member group are sorted. The total quantity of historical nodes in the historical consensus member group is counted. The total quantity of historical nodes in the historical consensus member group is divided by the tag hash to be verified to obtain a remainder result. The remainder result is the node number of the historical node corresponding to the historical transaction. If the node number of the historical node is the node number of the node, the verification is confirmed to be successful and the block to be verified is confirmed to be a legal block. If the node number of the historical node is not the node number of the node, the verification fails and the block to be verified is refused to be added to the node.

In order to better explain the embodiments of the present application, a blockchain transaction allocation method provided by the embodiments of the present application is introduced below in combination with an implementation scenario as shown in FIG. 5. The process of the method can be executed by any node in the blockchain system shown in FIG. 1, and includes the following steps.

The transaction to be allocated is set as TX1. The blockchain system consists of three sub-blockchains. The blockchain generates blocks of the three sub-blockchains, and the generated blocks are randomly allocated to the three sub-blockchains as shown in FIG. 5. The first sub-blockchain includes blocks C01, C02, C03, and C04. The second sub-blockchain includes blocks C11, C12, C13, C14, and C15. The third sub-blockchain includes blocks C21, C22, C23, and C24. The three sub-blockchains all point to the same genesis block GO. The direction of the logical clock line of the target block of the transaction to be allocated is the direction shown by the dotted line: block C04→block C14→block C24→block C23→block C22→block C21→genesis block G0. The preset difference is set to 3. Three clocks are advanced along the direction of the logical clock path of the bootstrap block (block 04) of the target block, block C23 is determined. Blocks at the same height as block C23 are determined, i.e., block C03 and block C13. The nodes generating blocks C23, C03, and C13 and the local node together constitute a consensus member group. The nodes in the consensus member group are sorted according to the binary value of node address of the nodes in the consensus member group. The total quantity of nodes in the consensus member group is counted. The hash of block C04 and the hash of the current transaction TX1 are used to generate the target tag hash. The total quantity of nodes in the consensus member group is divided by the target tag hash to obtain a remainder result. The remainder result is the node number assigned to the current transaction TX1. If it is consistent with the node number of the local node, the current transaction TX1 is added to the target block. The transaction allocation relationship between the transaction and the node corresponding to the target block is verified. If the verification passes, the target block is determined to be a legal block and added to the local blockchain. Otherwise, the target block is refused to be added to the local blockchain.

By allocating transactions to target nodes for processing, the problem of duplicate

transactions in high-concurrency blockchain systems can be effectively solved, and the actual transaction processing capabilities of the blockchain network can be significantly improved, thereby improving the throughput capacity of actual transactions in the blockchain network. In addition, by randomly allocating transactions to nodes of blockchains, dynamic adjustments can be made based on the latest status of the blocks, effectively preventing transactions from being filtered or monopolized by specific nodes, thereby improving the security and fairness of the entire blockchain network.

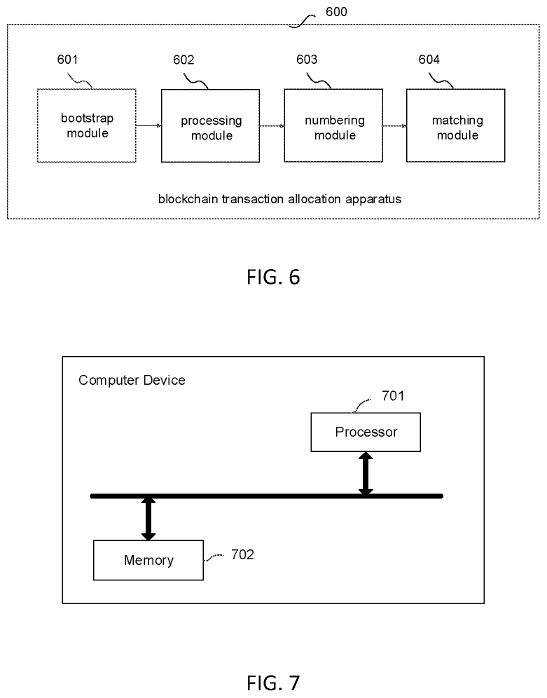

Based on the same technical concept, embodiments of the present application provide a schematic structure diagram of a blockchain transaction allocation apparatus, which is applied to any node in a blockchain system. As shown in FIG. 6, the apparatus 600 includes a bootstrap module 601, a processing module 602, a numbering module 603, and a matching module 604.

The bootstrap module 601 is configured to determine a bootstrap block pointed to by a target block of a transaction to be allocated. The bootstrap block is a legal block with a maximum logical clock detected by the local node when generating the target block.

The processing module 602 is configured to determine a consensus member group for allocating a target transaction based on the bootstrap block, and generate a target tag hash based on a transaction hash of the target transaction and a block hash of the bootstrap block.

The numbering module 603 is configured to assign a node number to a target node assigned to the target transaction based on the target tag hash and the total quantity of nodes in the consensus member group.

The matching module 604 is configured to add the target transaction to the target block if the node number of the target node is the node number of the local node.

By allocating transactions to target nodes for processing, the problem of duplicate

transactions in high-concurrency blockchain systems can be effectively solved, and the actual transaction processing capabilities of the blockchain network can be significantly improved, thereby improving the throughput capacity of actual transactions in the blockchain network. In addition, by randomly allocating transactions to nodes of blockchains, dynamic adjustments can be made based on the latest status of the block, effectively preventing transactions from being filtered or monopolized by specific nodes, thereby improving the security and fairness of the entire blockchain network.

Optionally, the bootstrap module 601 is configured to add the block hash of the bootstrap block to the corresponding field of the target block.

Optionally, the processing module 602 is configured to monitor the latest blocks of the main chain in each sub-blockchain.

If the difference between the logical clocks of any two latest blocks is less than or equal to a preset difference; or if the difference between the block heights of any two latest blocks is less than or equal to a preset difference, a consensus member group for allocating the target transaction is determined based on the bootstrap block.

Optionally, if the difference between the logical clocks of the two latest blocks is greater than the preset difference; or if the difference between the block heights of the two latest blocks is greater than the preset difference, the processing module 602 is configured to: randomly allocate the transaction to the target block, or not add the transaction to the target block.

Optionally, the processing module 602 is configured to: determine, from the main chain of each sub-blockchain, a plurality of historical blocks that meet a preset condition; and determine the consensus member group based on the plurality of historical blocks. The preset condition refers to: the distance to the logical clock or height of the bootstrap block is greater than or equal to a preset difference.

Optionally, the processing module 602 is configured to sort multiple nodes according to address information of the multiple nodes in the consensus member group and assign a node number to each node based on the sorting result.

Optionally, the numbering module 603 is configured to: take the remainder of the total quantity of nodes in the consensus member group divided by the target tag hash, to obtain a remainder result; and take the remainder result as the node number of the target node.

Optionally, the numbering module 603 is configured to skip the target transaction if the node number of the target node is not the node number of the local node.

Optionally, the processing module 602 is configured to: receive a block to be verified broadcasted by another node; verify the transaction allocation relationship between the historical transactions contained in the block to be verified and the node that generates the block to be verified; and determine that the block to be verified is a legal block if the verification passes.

Optionally, the processing module 602 is configured to: determine the tag hash to be verified based on the transaction hash of the historical transaction and the block hash of the bootstrap block corresponding to the block to be verified; determine the historical consensus member group for allocating the historical transaction based on the bootstrap block corresponding to the block to be verified; determine the node number of historical node corresponding to the historical transaction based on the tag hash to be verified and the total quantity of nodes in the historical consensus member group; and determine that the verification is passed if the node number of the historical node is the node number of the node.

By allocating transactions to target nodes for processing, the problem of duplicate transactions in high-concurrency block systems can be effectively solved, and the actual transaction processing capabilities of the blockchain network can be significantly improved, thereby improving the throughput capacity of actual transactions in the blockchain network. In addition, by randomly allocating transactions to nodes of blockchains, dynamic adjustments can be made based on the latest status of blocks, effectively preventing transactions from being filtered or monopolized by specific nodes, thereby improving the security and fairness of the entire blockchain network.

Based on the same technical concept, embodiments of the present application provide a computer device, as shown in FIG. 7, including at least one processor 701 and a memory 702 connected to the at least one processor. The specific connection medium between the processor 701 and the memory 702 is not limited in the embodiments of the present application. In FIG. 7, the processor 701 and the memory 702 are connected through a bus for example. The bus can be divided into address bus, data bus, control bus, etc.

In embodiments of the present application, the memory 702 stores instructions that can be executed by the at least one processor 701. The at least one processor 701 can execute the steps of the above-mentioned blockchain transaction allocation method by executing the instructions stored in the memory 702.

The processor 701 is the control center of the computer device, which can use various interfaces and lines to connect various parts of the computer device, and realize the transaction allocation of the blockchain by running or executing instructions stored in the memory 702 and calling the data stored in the memory 702. Optionally, the processor 701 may include one or more processing units. The processor 701 may integrate an application processor and a modem processor. The application processor mainly processes an operating system, a user interface, and application programs, etc., and the modem processor mainly processes wireless communications. It is understandable that the above-mentioned modem processor may not be integrated into the processor 701. In some embodiments, the processor 701 and the memory 702 may be implemented on the same chip. In some embodiments, they may also be implemented on separate chips.

The processor 701 can be a general-purpose processor, such as a central processing unit (CPU), a digital signal processor, an application-specific integrated circuit (ASIC), a field programmable gate array or other programmable logic device, a discrete gate or transistor logic device, or a discrete hardware component, and can implement or execute the methods, steps, and logic block diagrams disclosed in the embodiments of the present application. A general purpose processor may be a microprocessor or any conventional processor or the like. The steps of the method disclosed in the embodiments of the present application can be directly implemented as being executed by a hardware processor, or can be implemented by a combination of hardware and software modules in the processor.

The memory 702 is a non-transitory computer-readable storage medium that can be used to store non-transitory software programs, non-transitory computer executable programs, and modules. The memory 702 may include at least one type of storage medium, for example, a flash memory, a hard disk, a multimedia card, a card-type memory, a random access memory (Random Access Memory, RAM), a static random access memory (Static Random Access Memory, SRAM), a programmable read-only memory (Programmable Read Only Memory, PROM), a read-only memory (Read Only Memory, ROM), an electrically erasable programmable read-only memory (Electrically Erasable Programmable Read-Only Memory, EEPROM), a magnetic memory, a disk, an optical disk, and the like. Memory 702 may be, but is not limited to, any other medium that can be used to carry or store desired program code in the form of instructions or data structures and that can be accessed by a computer. The memory 702 in the embodiments of the present application may also be a circuit or any other device capable of implementing a storage function, for storing program instructions and/or data.

Based on the same inventive concept, embodiments of the present application provide a computer-readable storage medium, which stores a computer program that can be executed by a computer device. When the program runs on the computer device, the computer device executes the steps of the above-mentioned blockchain transaction allocation method.

Those skilled in the art should understand that the embodiments of the present application may be provided as methods, systems, or computer program products. Therefore, the present application may take the form of an entirely hardware embodiment, an entirely software embodiment, or an embodiment combining software and hardware aspects. Moreover, the present application may take the form of a computer program product implemented on one or more computer-usable storage media (including but not limited to disk storage, CD-ROM, optical storage, etc.) containing computer-usable program codes.

The present application is described with reference to flowcharts and/or block diagrams of methods, apparatus (systems), and computer program products according to the present application. It should be understood that each process and/or block in the flowchart and/or block diagram, and a combination of the processes and/or blocks in the flowchart and/or block diagram can be implemented by computer program instructions. These computer program instructions can be provided to a processor of a general-purpose computer, a special-purpose computer, an embedded processor or other programmable data processing device to produce a machine, so that the instructions executed by the processor of the computer or other programmable data processing device produce a device for implementing the functions specified in one or more processes in the flowchart and/or one or more blocks in the block diagram.

These computer program instructions may also be stored in a computer-readable memory that can direct a computer or other programmable data processing device to operate in a specific manner, so that the instructions stored in the computer-readable memory produce a manufactured product including an instruction device that implements the functions specified in one or more processes in the flowchart and/or one or more boxes in the block diagram.

These computer program instructions may also be loaded onto a computer or other programmable data processing device so that a series of operational steps are executed on the computer or other programmable device to produce a computer-implemented process, whereby the instructions executed on the computer or other programmable device provide steps for implementing the functions specified in one or more processes in the flowchart and/or one or more boxes in the block diagram.

Obviously, those skilled in the art can make various changes and modifications to the present application without departing from the spirit and scope of the present application. Thus, if these modifications and variations of the present application fall within the scope of the claims of the present application and their equivalent technologies, the present application is also intended to include these modifications and variations.

1. A blockchain transaction allocation method performed by any node in a blockchain system, wherein the method comprises:
determining a bootstrap block pointed to by a target block of a transaction to be allocated, wherein the bootstrap block is a legal block with a maximum logical clock detected by a local node when generating the target block;
determining a consensus member group for allocating a target transaction based on the bootstrap block, and generating a target tag hash based on a transaction hash of the target transaction and a block hash of the bootstrap block;
assigning a node number to a target node assigned to the target transaction based on the target tag hash and a total quantity of nodes in the consensus member group;
adding the target transaction to the target block based on that the node number of the target node is a node number of the local node.

2. The method according to claim 1, wherein after determining the bootstrap block pointed to by the target block of the transaction to be allocated, the method further comprises:
adding the block hash of the bootstrap block to a corresponding field of the target block.

3. The method of claim 1, wherein the determining the consensus member group for allocating the target transaction based on the bootstrap block comprises:
monitoring latest blocks of main chains in sub-blockchains;
determining the consensus member group for allocating the target transaction based on the bootstrap block, based on that a difference between logical clocks of any two latest blocks is less than or equal to a preset difference, or based on that a difference between block heights of any two latest blocks is less than or equal to the preset difference.

4. The method according to claim 3, further comprising:
randomly allocating the transaction to the target block, or not adding the target transaction to the target block, based on that the difference between the logical clocks of two latest blocks is greater than the preset difference, or based on that the difference between the block heights of two latest blocks is greater than the preset difference.

5. The method of claim 1, wherein the determining the consensus member group for allocating the target transaction based on the bootstrap block comprises:
determining, from main chains of sub-blockchains, a plurality of historical blocks that meet a preset condition, wherein the preset condition refers to: a distance to a logical clock or height of the bootstrap block is greater than or equal to a preset difference;
determining the consensus member group based on the plurality of historical blocks.

6. The method of claim 5, wherein after determining the consensus member group based on the plurality of historical blocks, the method further comprises:
sorting a plurality of nodes in the consensus member group according to address information of the plurality of nodes; and
assigning a node number to each of the plurality of nodes based on a result of the sorting.

7. The method of claim 1, wherein the assigning the node number to the target node assigned to the target transaction based on the target tag hash and the total quantity of nodes in the consensus member group comprises:
taking a remainder of the total quantity of nodes in the consensus member group divided by the target tag hash to obtain a remainder result;
taking the remainder result as the node number of the target node.

8. The method according to claim 1, further comprising:
skipping the target transaction based on that the node number of the target node is not the node number of the local node.

9. The method according to 8 claim 1, further comprising:
receiving a block to be verified broadcasted by another node;
verifying a transaction allocation relationship between a historical transaction comprised in the block to be verified and a node that generates the block to be verified;
determining that the block to be verified is a legal block based on that a result of the verifying is pass.

10. The method according to claim 9, wherein the verifying the transaction allocation relationship between the historical transaction comprised in the block to be verified and the node that generates the block to be verified comprises:
determining a tag hash to be verified based on a transaction hash of the historical transaction and a block hash of a bootstrap block corresponding to the block to be verified; and determining a historical consensus member group for allocating the historical transaction based on the bootstrap block corresponding to the block to be verified;
determining a node number of a historical node corresponding to the historical transaction based on the tag hash to be verified and a total quantity of nodes in the historical consensus member group;
determining that the result of the verifying is pass based on that the node number of the historical node is a node number of the node that generates the block to be verified.

11. Blockchain transaction allocation apparatus applied to any node in a blockchain system, comprising:
a bootstrap module, configured to determine a bootstrap block pointed to by a target block of a transaction to be allocated, wherein the bootstrap block is a legal block with a maximum logical clock detected by a local node when generating the target block;
a processing module, configured to determine a consensus member group for allocating a target transaction based on the bootstrap block, and to generate a target tag hash based on a transaction hash of the target transaction and a block hash of the bootstrap block;
a numbering module, configured to assign a node number to a target node assigned to the target transaction based on the target tag hash and a total quantity of nodes in the consensus member group;
a matching module, configured to add the target transaction to the target block based on that the node number of the target node is a node number of the local node.

12. A computer device comprises a memory, a processor and a computer program stored in the memory and executable on the processor, wherein the processor implements steps of the method according to claim 1 when executing the computer program.

13. A non-transitory computer-readable storage medium storing a computer program executable by a computer device, wherein when the computer program is run on the computer device, the computer device performs steps of the method according to claim 1.
